(19) United States
(12) Patent Application Publication
(10) Pub. No.: US 2005/0159964 A1
(43) Pub. Date: Jul. 21, 2005

(54) Method and device for recording operational data

(76) Inventors: Thomas Sonnenrein, Bockenem (DE); Michael Laedke, Hildesheim (DE)

Correspondence Address: KENYON & KENYON, ONE BROADWAY, NEW YORK, NY, 10004, US

(21) Appl. No.: 10/507,535

(22) PCT Filed: Feb. 21, 2003
(86) PCT No.: PCT/DE03/00549

(30) Foreign Application Priority Data
Mar. 13, 2002 (DE) 10210973.7

(51) Int. Cl. G06F 17/60

(52) U.S. Cl. 705/1

(57) ABSTRACT

The method described is used for recording operating data of a technical device. According to the method, a command sequence is initially generated, which is transmitted to a monitoring unit in the technical device. The command sequence is processed in a processing unit in the monitoring unit. In addition, a device for recording operating data and a computer program for implementing the method according to the present invention are provided.

### FIELD OF THE INVENTION

The present invention relates to a method and a device for recording operating data, in particular for recording vehicle operating data.

### BACKGROUND INFORMATION

In motor vehicles, trip recorders or log books are used to record various data such as the time of day, speed, geographical position, driver confirmations and operating data. There are already electronic logbooks in use that allow for data to be stored locally in the vehicle and to be read out via special interfaces. The recorded data can be transmitted wirelessly to another point, e.g. to an evaluation unit. Fields of application for these logbooks include, for example, vehicle fleet management, trip recorders in trucks or also private individuals who are required to furnish proof of their driving activities, for the tax authorities for example. A disadvantage of the known logbooks, however, is the fact that they can be used only for specific applications. The user can select from a series of fixed functions, for example the functions of storing the geographical position, the time of day and the odometer reading. The desired function is usually selected by operating function keys.

German Published Patent Application No. 198 50 057 describes a device and a method for recording the movements of a mobile unit, for example, a vehicle. The device described features a mobile telephone terminal which is connectable or is connected to the main station of a mobile telephone network. In the main station, movements of the unit and optionally additional information are registered, recorded and documented. The device described is thus used as an electronic trip recorder supported by mobile telephony, a trip recorder which is to replace the usual trip logbooks that have to be kept by hand.

European Published Patent Application No. 0 929 879 describes a method for transmitting collected data from a plurality of vehicles to a data processing station as well as a device for collecting data in a vehicle and for transmitting the collected data to a data processing station.

According to the method described, in a first step, a first type of request packet is transmitted from every vehicle via a released radio channel in response to a previously defined operation. This first packet type is registered by a data processing station if a transmitting vehicle is near the processing station. In registering the first packet type, an instruction for data is transmitted from the receiving station in the form of a second packet type. In response to the instruction, a portion of the collected data is transmitted by a registered vehicle.

The methods and devices described in the documents only allow for functions already defined to be implemented wirelessly in the trip recorder and for the wireless retrieval of data obtained.

### SUMMARY OF THE INVENTION

By contrast, the method according to the present invention for recording operating data of a motor vehicle provides for the generation of a command sequence and the transmission of is command sequence to a monitoring unit in the motor vehicle. The command sequence is processed in a processing unit in the monitoring unit. The command sequence (macro) represents a series of instructions that can be interpreted and executed by the processing unit. This allows for the execution of specific functions aimed at particular cases. The user is not limited to preset functions, but is rather able to react individually to external events and to configure the trip recorder accordingly.

The monitoring unit used in the method according to the present invention is thus configurable in a flexible manner, can be programmed from a remote location and serves as a trip recorder or logbook for recording relevant data. The command sequence can be used to specify which data will be recorded and optionally read out.

The command sequence preferably specifies the type of operating data recording, i.e. it is also possible to determine which data are to be recorded at which locations.

The command sequence can also be parameterized. In this case, the type of operating data recording will be dependent on the engine speed or the temperature of the engine oil for example.

The command sequence is preferably generated at a remote location and then [transmitted] from this location, e.g. from a service provider or home computer, to the motor vehicle.

A mobile telephone network is a suitable candidate for a transmission medium for transmitting the command sequence. In this case, a cellular telephone is used as an interface to the transmission medium. The command sequence, however, may also be transmitted via a mobile storage medium.

Prior to processing in the processing unit, the command sequence is preferably checked for plausibility and is stored in a storage unit, for example a nonvolatile, rewritable storage device. This ensures that incorrect command sequences or macros are not executed.

Following or during the execution of the macro, the requested data are stored in the storage unit and/or transmitted.

A refinement of the method according to the present invention provides for transmitting messages when specific criteria or conditions are met. This can be applied in the case of a rental car, for example, which may only be used within a circumscribed region. When the boundaries of this region are crossed, a message will be sent to the main station.

The device according to the present invention features a processing unit, a storage unit and a communication module.

The sequence control of the commands contained in the macro occurs in the processing unit. The device according to the present invention has access to vehicle operating data which may be transmitted via the communication module. The plausibility check may also be conducted in the processing unit or CPU.

Preferably display and operational control elements are provided. These elements allow the driver of a motor vehicle to access data of interest directly and to establish a communication connection with an evaluation station. The user is thereby also able to view the recorded data and optionally to have it deleted or read out.

In a refinement of the present invention, the storage unit features a volatile and a nonvolatile rewritable storage device. The combinations (static or dynamic) of the data to be recorded, the macros and the temporarily recorded data are preferably stored in the nonvolatile storage device.

Another method according to the present invention provides that a generated command sequence is received by a monitoring unit in a motor vehicle and that this command sequence is processed in a processing unit in the monitoring unit.

The computer program according to the present invention includes program code means for implementing this method according to the present invention and is thus executed in the processing unit of the monitoring unit. A computer program, however, may also be used for generating and transmitting the command sequence.

The computer program product is stored on a computer-readable storage medium. EEPROMs and flash memories, but also CD-ROMs, diskettes and hard disk drives are used as suitable storage media.

Further advantages and refinements of the present invention come to light from the description and the accompanying drawing.

It goes without saying that the features indicated above or yet to be explicated in the following are usable not only in the combination specified in each instance, but also in other combinations or by themselves, without departing from the scope of the present invention.

### BRIEF DESCRIPTION OF THE DRAWINGS

FIG. 1 shows a preferred specific embodiment of the device according to the present invention in schematic representation.

FIG. 2 shows the structure of a command sequence in schematic representation.

FIG. 3 shows a specific embodiment of the method of the present invention in a flow chart.

### DETAILED DESCRIPTION

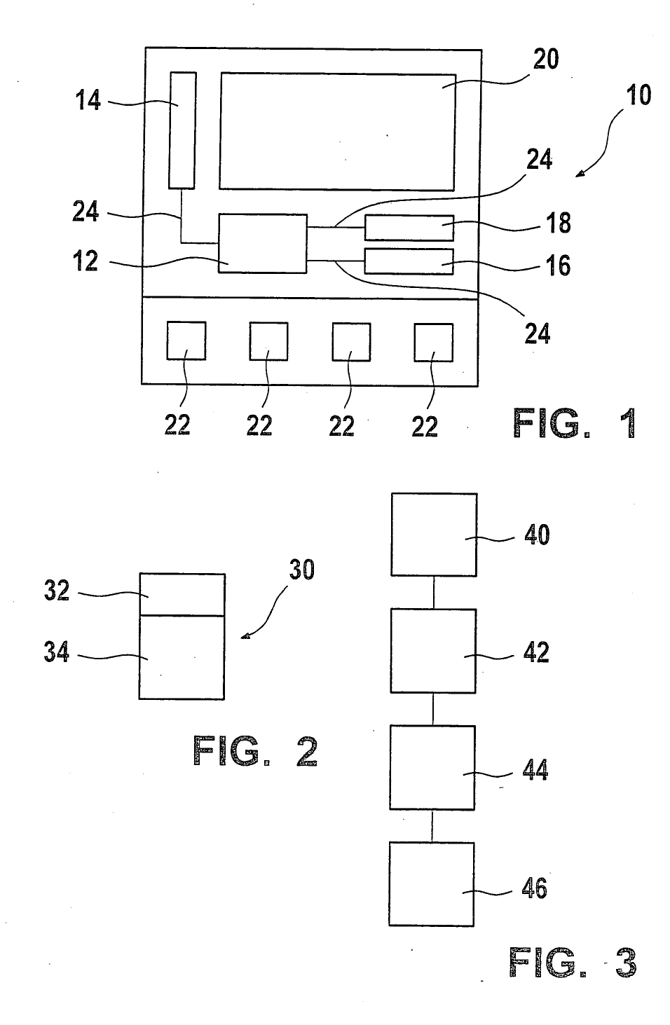

FIG. 1 shows a preferred specific embodiment of the device according to the present invention, a monitoring unit 10. A processing unit 12, a communication module 14, a volatile storage device 16, and nonvolatile rewritable storage device 18, a display unit 20 and four operational control elements 22 can be seen. The components are connected to one another via data lines 24.

Monitoring unit 10 represents a flexibly configurable logbook programmable via mobile telephony. When used in a motor vehicle, this allows for the automatic initialization and launching of monitoring processes which are specified by parameters and uniformly structured mechanisms (macros) for recording operating data.

The command sequences or macros are received via communication module 14 and are first advantageously checked for plausibility by processing unit 12.

Communication module 14 preferably represents an interface to the mobile telephone network. In a refinement of the present invention, communication module 14 is developed as a socket or even as an adapter, in which a mobile telephone can be inserted for data transmission.

The command sequence is typically stored in the nonvolatile storage device and is processed. In this manner it is also possible to generate a log regarding all command sequences received and processed over a specific period.

In addition to recording operating data, messages may also be generated and sent via the mobile telephone system. The releasing criteria for these messages are set by appropriate parameters. Such criteria may be met for example by the exceeding of logical and/or physical limiting values and of corresponding combinations. Also the generation of cyclical messages according to fixed time patterns as well as the targeted query of logbook data, e.g. by a service center, may be provided.

Monitoring unit 10 also makes it possible for the user to affect the execution of the command sequence using operational control elements 22 and to have specific data presented on display unit 20.

Automatic monitoring, for example, may be provided for wear limits and expendable supplies so as to ensure an early detection of critical status parameters and to offer warning signals as part of a pre-diagnosis and the individual recording of operating data for the purpose of furnishing proof. The advantage as compared to classical methods of static data recording lies in the flexible programmability of automatic and mutually independent monitoring processes.

FIG. 2 shows the structure of a command sequence or macro. Macro 30 contains the elements functions 32 and data 34. Element functions 32 describes the functional sequence of the commands to be executed and the data which are to be recorded and/or processed in the monitored vehicle. Element data 34 contains, for example, comparison parameters and boundary values required for executing functions 32.

FIG. 3 illustrates in a flow chart the sequence of a preferred specific embodiment of the method according to the present invention. In a step 40, macro 30 is generated by a central station and transmitted to a vehicle. Processing unit 12 checks macro 30 for plausibility in a step 42. In a step 44, macro 30 is subsequently stored in nonvolatile storage device 18. Afterwards, the command sequence or macro is executed in a step 46.

An example of an application of the method according to the present invention is described below. In this application, a vehicle is given a specific geographical residence permit, i.e. the vehicle may only be operated within specific geographical boundaries. With the aid of the configurable logbook, positional data are recorded only when the vehicle leaves its area of residence.

Possible applications exist, for example, in car rental agencies which rent vehicles to be operated only in specific countries or to be used only within a limited operating radius.

In the corresponding command sequence, current positional data are compared to the positional data in macro 30. In the case of deviations, these data are stored for the time being and optionally a corresponding message is generated which is transmitted via a mobile telephone system. This process is cyclically repeated.

Additional applications for the device according to the present invention are in theft-deterrence features, where, in case of a vehicle theft, a message is generated to the main station or an intervention is made in the engine control unit and the next start is prevented (anti-theft blocking).

Furthermore, it is possible to log trips, the log structure being modifiable as desired. Odometer readings, positional data, times of day and comparable information may be recorded for example. This thus represents an expanded trip recorder functionality. Individual logs may also be transmitted wirelessly to a main station. Possible applications for this are the evaluation of the legal position in the wake of an accident, the furnishing of a tax receipt for taxation authorities or a receipt for an employer.

The device according to the present invention also allows for the monitoring of engine characteristic curves and operating data. For this purpose, operating data of the engine control unit are recorded when previously defined limiting values are exceeded. This occurs, for example, when the maximum engine speed or the maximum temperature are exceeded and may be used, for example, in connection with a manufacturer's warranty as evidence of incorrect usage or in connection with a mobility guarantee.

Moreover, special cargo may be monitored as well, i.e. temperature monitoring cycles are provided which can be dynamically adjusted to the current cargo. In addition, fuel consumption may also be ascertained, as proof for invoicing purposes for example.

It is also possible to ascertain emissions. This may be used as proof of the correct functioning of the catalytic converter. Special exhaust gas analyses may thereby be simplified or avoided.

Monitoring of special parts subject to wear can also be implemented, for example for calculating the mileage of tires following a new installation, the mileage since the last oil change and the mileage since the renewal of the braking system.

1-15. (canceled)

16. A method for recording operating data of a motor vehicle, comprising:
generating a command sequence;
transmitting the command sequence to a monitoring unit in the motor vehicle; and
processing the command sequence in a processing unit in the monitoring unit.

17. The method as recited in claim 16, wherein:
the command sequence determines a type of operating data recording.

18. The method as recited in claim 16, wherein:
the command sequence is generated in a remote location and is transmitted wirelessly from the remote location to the processing unit.

19. The method as recited in claim 16, wherein:
the command sequence is transmitted by a mobile storage medium.

20. The method as recited in claim 16, wherein:
the command sequence is transmitted via a mobile telephone network.

21. The method as recited in claim 16, further comprising:
checking the command sequence in the processing unit.

22. The method as recited in claim 16, further comprising:
storing the command sequence in a storage unit.

23. The method as recited in claim 16, further comprising:
transmitting data from the monitoring unit.

24. The method as recited in claim 16, further comprising:
transmitting a message when a specific criterion is met.

25. A device for recording operating data, comprising:
an arrangement for generating a command sequence;
a communication module for transmitting the command sequence to a monitoring unit in the motor vehicle;
a processing unit for processing the command sequence; and
a storage unit.

26. The device as recited in claim 25, further comprising:
a display unit.

27. The device as recited in claim 25, further comprising:
operational control elements.

28. A method for recording operating data of a motor vehicle, comprising:
causing a monitoring unit in the motor vehicle to receive a generated command sequence; and
processing the generated command sequence in a processing unit in the monitoring unit.

29. A recording medium storing a computer program that when executed results in a performance of a method comprising:
generating a command sequence;
transmitting the command sequence to a monitoring unit in a motor vehicle; and
processing the command sequence in a processing unit in the monitoring unit.
